(19) United States
(12) Patent Application Publication
(10) Pub. No.: US 2023/0246194 A1
(43) Pub. Date: Aug. 3, 2023

(54) ELECTRODES AND METHODS OF MANUFACTURE WITH RADIATION CURABLE POLYMERS AND/OR DISPERSION ADDITIVES

(71) Applicant: Ocella, Inc., Newberry, IN (US)

(72) Inventors: Rajan Kumar, Bloomington, IN (US); Kevin Barry, Bloomington, IN (US)

(21) Appl. No.: 18/163,121

(22) Filed: Feb. 1, 2023

Related U.S. Application Data
(63) Continuation of application No. 63/267,521, filed on Feb. 3, 2022.

(51) Int. Cl. H01M 4/62; H01M 4/485; H01M 4/583; H01M 4/04; H01M 10/0525

(52) U.S. Cl. CPC H01M 4/622; H01M 4/485; H01M 4/5835; H01M 4/0404; H01M 4/625; H01M 4/0471; H01M 10/0525; H01M 2004/027

(57) ABSTRACT

Electrode films utilizing cathode or anode active materials, such as cathode electrode films utilizing carbon monofluoride (CFx) or MnO₂ as the cathode active material, and/or including a surfactant are described. The electrode film may utilize binders including acrylated polyurethane resins, hydroxy modified acrylated polyurethane resins, acrylate-methacrylate monomer blends, monoacrylate of mono-ethoxylated phenols, celluloses, trimethylolpropane ethoxy triacrylate (TMPEOTA), polytetrafluoroethylene (PTFE), polyolefins, polyalkylenes, polyethers, styrene-butadiene, co-polymers of polysiloxanes, polysiloxanes, branched polyethers, polyvinylethers, co-polymers thereof, and combinations thereof. The electrode film may further include additives. The electrode films may be electron beam cured.

### INCORPORATION BY REFERENCE TO ANY PRIORITY APPLICATIONS

Any and all applications for which a foreign or domestic priority claim is identified in the Application Data Sheet or PCT Request as filed with the present application are hereby incorporated by reference under 37 CFR 1.57, and Rules 4.18 and 20.6, including U.S. Provisional Application No. 63/267,521, filed Feb. 3, 2022.

### BACKGROUND

### Field

The present invention relates to energy storage devices, particularly to compositions of and methods for fabricating energy storage device electrodes.

### Description of the Related Art

Various types of energy storage devices can be used to power electronic devices, including for example, capacitors, batteries, capacitor-battery hybrids and/or fuel cells. An energy storage device, such as a traditional or solid-state lithium ion capacitor or battery, having an electrode prepared using an improved electrode formulation and/or fabrication process can facilitate improved electrical performance. A lithium ion capacitor or battery having an electrode prepared using an improved electrode formulation and/or fabrication process may demonstrate improved cycling performance, reduced equivalent series resistance (ESR) values, increased power density performance and/or increased energy density performance. Improved electrode formulations and/or fabrication processes may also facilitate lower costs of energy storage device fabrication.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

In one aspect, a cathode electrode film is described. The cathode electrode film includes: a cathode active material comprising a material selected from the group consisting of carbon monofluoride, manganese dioxide and combinations thereof; and a binder selected from the group consisting of an acrylated polyurethane resin, a hydroxy modified acrylated polyurethane resin, an acrylate-methacrylate monomer blend, a monoacrylate of mono-ethoxylated phenol, a cellulose, trimethylolpropane ethoxy triacrylate (TMPEOTA), polytetrafluoroethylene (PTFE), a polyolefin, polyalkylenes, polyethers, styrene-butadiene, co-polymers of polysiloxanes, a polysiloxane, branched polyethers, polyvinylethers, co-polymers thereof, and combinations thereof.

In some embodiments, the polyolefin is selected from the group consisting of polyethylene (PE), polypropylene (PP), polyvinylidene fluoride (PVDF), co-polymers thereof, and combinations thereof.

In some embodiments, a cathode electrode is described, comprising: a current collector; and the cathode electrode film disposed over the current collector. In some embodiments, the cathode electrode further comprises a carbon coating disposed between the current collector and the cathode electrode film.

In some embodiments, an energy storage device is described, comprising: the cathode electrode; an anode electrode; and a housing, wherein the cathode and anode electrodes are disposed within the housing.

In some embodiments, a method of fabricating the cathode electrode is described, comprising: combining the cathode active material, binder and a solvent to form a slurry; and casting the slurry over the current collector to form the cathode electrode. In some embodiments, the method further comprises exposing the cathode electrode to an electron beam.

In another aspect, an electrode film is described. The electrode film includes: an active material; and a binder selected from the group consisting of an acrylated polyurethane resin, a hydroxy modified acrylated polyurethane resin, an acrylate-methacrylate monomer blend, a monoacrylate of mono-ethoxylated phenol, a cellulose, trimethylolpropane ethoxy triacrylate (TMPEOTA), polytetrafluoroethylene (PTFE), a polyolefin, polyalkylenes, polyethers, styrene-butadiene, co-polymers of polysiloxanes, a polysiloxane, branched polyethers, polyvinylethers, co-polymers thereof, and combinations thereof.

In some embodiments, the active material is an anode active material.

In another aspect, an electrode film is described. The electrode film includes: an active material; a binder selected from the group consisting of an acrylated polyurethane resin, a hydroxy modified acrylated polyurethane resin, an acrylate-methacrylate monomer blend, a monoacrylate of mono-ethoxylated phenol, a cellulose, trimethylolpropane ethoxy triacrylate (TMPEOTA), polytetrafluoroethylene (PTFE), a polyolefin, polyalkylenes, polyethers, styrene-butadiene, co-polymers of polysiloxanes, a polysiloxane, branched polyethers, polyvinylethers, co-polymers thereof, and combinations thereof, and a surfactant.

In some embodiments, the active material is a cathode active material. In some embodiments, the cathode active material is selected from the group consisting of carbon monofluoride, manganese dioxide, lithium iron phosphate (LFP), lithium cobalt oxide (LCO), nickel manganese cobalt oxide (NMC), nickel cobalt aluminum oxide (NCA), lithium titanate (LTO), lithium manganese iron phosphate (LMFP), and combinations thereof. In some embodiments, the electrode film comprises about 85-95 wt. % of the active material.

In some embodiments, the surfactant is selected from the group of consisting of a non-ionic surfactant, a polymeric surfactant, and combinations thereof. In some embodiments, the surfactant comprises a molecular weight of at most about 50,000 g/mol. In some embodiments, the surfactant is selected from the group consisting of a polyethylene glycol derivative, polyvinylpyrrolidone, poly(ethyleneimine), poly(acrylic acid), and combinations thereof. In some embodiments, the electrode film comprises about 0.01-0.5 wt. % of surfactant.

In some embodiments, the electrode film further comprises a conductive additive. In some embodiments, the electrode film comprises about 1-10 wt. % of the conductive additive. In some embodiments, the electrode film comprises about 3-15 wt. % of the binder.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

These and other features, aspects, and advantages of the present disclosure are described with reference to the drawings of certain embodiments, which are intended to illustrate certain embodiments and not to limit the invention.

FIG. 1 shows the assembly structure of a coin cell, according to some embodiments.

FIG. 2 shows FTIR spectra for resin samples exposed to varying amounts of electron beams, according to some embodiments.

FIG. 3 shows the results of the LSV measurements for cells prepared, according to some embodiments.

FIG. 4A shows the galvanostatic discharge data of a cell as plots of voltage as a function of specific capacity, according to some embodiments.

FIG. 4B shows the galvanostatic discharge data of a cell as plots of voltage as a function of specific capacity, according to some embodiments.

FIG. 4C shows the galvanostatic discharge data of a cell as plots of voltage as a function of specific capacity, according to some embodiments.

FIG. 4D shows the galvanostatic discharge data of a cell as plots of voltage as a function of specific capacity, according to some embodiments.

FIG. 5 shows the specific capacities of cells as a function of discharge current, according to some embodiments.

FIG. 6A shows the performance metrics of cells at the different weight loadings, according to some embodiments.

FIG. 6B shows the performance metrics of cells at the same weight loadings, according to some embodiments.

FIG. 7A shows a comparison of the pulsing performance, according to some embodiments.

FIG. 7B shows a comparison of the pulsing performance, according to some embodiments.

FIG. 8 shows a comparison of the pulsing performance, according to some embodiments.

FIG. 9 shows the specific capacity of energy storage devices, according to some embodiments.

FIG. 10A shows the galvanostatic discharge data of MnO₂ cells with an EB cured binder as plots of voltage as a function of specific capacity, according to some embodiments.

FIG. 10B shows the galvanostatic discharge data of MnO₂ cells with a PVDF binder as plots of voltage as a function of specific capacity, according to some embodiments.

### DETAILED DESCRIPTION

Although certain embodiments and examples are described below, those of skill in the art will appreciate that the invention extends beyond the specifically disclosed embodiments and/or uses and obvious modifications and equivalents thereof. Thus, it is intended that the scope of the invention herein disclosed should not be limited by any particular embodiments described below.

Cathode electrode films utilizing carbon monofluoride (CFx) and other active materials are described, as well as electrode films utilizing surfactants. The electrode may utilize binders, for example including acrylated polyurethane resins, acrylate-methacrylate monomer blends, monoacrylate of mono-ethoxylated phenols, polyvinylidene fluoride (PVDF), and combinations thereof. The electrodes may be electron beam cured. Such electrode architectures, such as homogeneous electrodes, heterogeneous electrodes, single layer electrodes and/or multilayer electrodes (e.g., heterogeneous multilayer thin film electrodes), may be flexible and/or bendable, and utilized in energy storage devices used in the internet of things (JOT) and wearables spaces. For example, some devices require sufficient Bluetooth pulsing performance such as the requirements of a Nordic nRF52832 BLE module, wherein it is critical that the voltage of the power source never drop below about 1.8 V or about 2.0 V during the sleep mode and transmission mode, otherwise the BLE connection between the sensor and reader would be disconnected.

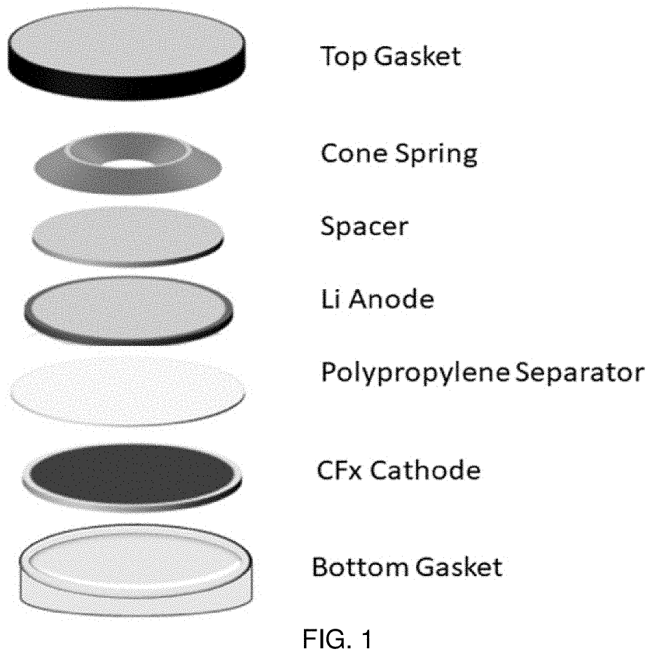

Energy storage devices including the cathode electrodes described herein can be primary or rechargeable energy storage devices, and in various forms. For example, FIG. 1 shows the assembly structure of a Lithium-CFx coin cell. The cell of FIG. 1 shows a CFx cathode oppositely disposed from a lithium anode and separated by a separator (e.g. shown as a polypropylene separator), wherein a bottom gasket is disposed under the CFx cathode and a spacer, cone spring and top gasket are sequentially disposed over the lithium anode. Prior to assembly and sealing the cell may be filled with an electrolyte. In some embodiments, the energy storage device is a battery, a capacitor, or a combination thereof. In some embodiments, the energy storage device is a solid state energy storage device such that the energy storage device includes a solid state electrolyte positioned between the cathode and anode. In some embodiments, the solid state electrolyte is in a semisolid (e.g., gel) or solid form.

Energy storage devices may include a first electrode that includes a first current collector in contact with a first electrode film (e.g. a cathode electrode with a cathode electrode film), and a second electrode that includes a second current collector in contact with a second electrode film (e.g. an anode electrode with an anode electrode film). The first current collector and the second current collector may facilitate electrical coupling between each corresponding electrode film and an external circuit (not shown). For example, a current collector can include a metallic material, such as a material comprising aluminum, nickel, copper, rhenium, niobium, tantalum, and noble metals such as silver, gold, platinum, palladium, rhodium, osmium, iridium and alloys and combinations of the foregoing. For example, a current collector can comprise, for example, an aluminum foil or a copper foil. An electrode includes at least one electrode film on or disposed over a surface of a current collector. In some embodiments, an electrode may be a multilayer electrode and comprise more than one electrode film, for example, such as a first electrode film and second electrode film disposed on the same or different sides of a current collector. In some embodiments, the multilayered electrode is heterogeneous such that the properties, loading, thickness and/or composition of a first electrode film is different than that of a second electrode film of the electrode.

An electrode film may comprise a cathode active material or an anode active material. In some embodiments, the electrode film comprises the active material in, in about, in at least, or in at least about, 60 wt. %, 65 wt. %, 70 wt. %, 75 wt. %, 80 wt. %, 83 wt. %, 84 wt. %, 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. % or 99 wt. %, or any range of values therebetween.

The cathode active material can include, for example, carbon monofluoride (CFx), metal oxide, metal sulfide, or a lithium metal oxide. The lithium metal oxide can be, for example, a lithium nickel manganese cobalt oxide (NMC), a lithium manganese oxide (LMO), a lithium iron phosphate (LFP), a lithium cobalt oxide (LCO), a lithium titanate (LTO), and/or a lithium nickel cobalt aluminum oxide (NCA). In some embodiments, cathode active materials can comprise, for example, a layered transition metal oxide (such as LiCoO₂ (LCO), Li(NiMnCo)O₂ (NMC) and/or LiNi_{0.8}Co_{0.15}Al_{0.05}O₂ (NCA)), a spinel manganese oxide (such as LiMn₂O₄ (LMO) and/or LiMn_{1.5}Ni_{0.15}O₄ (LMNO)), an olivine (such as LiFePO₄), chalcogenides (LiTiS₂), tavorite (LiFeSO₄F), silicon, silicon oxide (SiOx), aluminum, tin, tin oxide (SnOx), manganese oxide (MnOx) (e.g., manganese dioxide “MnO₂”), molybdenum oxide (MoO₂), molybdenum disulfide (MoS₂), nickel oxide (NiOx), or copper oxide (CuOx).

The anode active materials can include, for example, an insertion material (such as carbon, graphite (natural, synthetic or blends), hard or amorphous carbons and/or graphene), an alloying/dealloying material (such as silicon, silicon oxide, tin, and/or tin oxide), a metallic element, metal alloy or compound (such as Si—Al, and/or Si—Sn), and/or a conversion material (such as manganese oxide, molybdenum oxide, nickel oxide, and/or copper oxide). The anode active materials can be used alone or mixed together to form multi-phase materials (such as Si—C, Sn—C, SiOx-C, SnOx-C, Si—Sn, Si-SiOx, Sn-SnOx, Si-SiOx-C, Sn-SnOx-C, Si—Sn—C, SiOx-SnOx-C, Si-SiOx-Sn, or Sn-SiOx-SnOx.).

The electrode film may comprise a binder. In some embodiments the electrode film comprises the binder or binders in, in about, in at most, in at most about, 0.5 wt. %, 1 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. % or 25 wt. %, or any range of values therebetween. In some embodiments, the binder is a polymerizable binder. In some embodiments, the polymerizable binder is electron beam (“e-beam” or “EB”) polymerizable. Binders may include an acrylated polyurethane resin (e.g. Ucecoat 7689, Ucecoat 7510, and Ucecoat 7690 (i.e. a polyurethane acrylate, acrylate ester and/or acrylated monomer dispersion in water)), a hydroxy modified acrylated polyurethane resin (e.g., hydroxy modified Ucecoat 7690), an acrylate-methacrylate monomer blend (e.g. Ebecryl 109), a monoacrylate of mono-ethoxylated phenol (e.g. Ebecryl 114), trimethylolpropane ethoxy triacrylate (TMPEOTA), polytetrafluoroethylene (PTFE), a polyolefin, polyalkylenes, polyethers, styrene-butadiene, co-polymers of polysiloxanes, a polysiloxane, branched polyethers, polyvinylethers, co-polymers thereof, and/or admixtures thereof. The binder can include a cellulose, for example, carboxymethylcellulose (CMC). In some embodiments, the polyolefin can include polyethylene (PE), polypropylene (PP), polyvinylidene fluoride (PVDF), co-polymers thereof, and/or mixtures thereof. For example, the binder can include polyvinylene chloride, poly(phenylene oxide) (PPO), polyethylene-block-poly(ethylene glycol), poly(ethylene oxide) (PEO), poly(phenylene oxide) (PPO), polyethylene-block-poly(ethylene glycol), polydimethylsiloxane (PDMS), polydimethylsiloxane-coalkylmethylsiloxane, co-polymers thereof, and/or admixtures thereof. In some embodiments, the binder may include an acrylated polyurethane resin, an acrylate-methacrylate monomer blend, a monoacrylate of mono-ethoxylated phenol, polyvinylidene fluoride (PVDF), and combinations thereof. In some embodiments, the binder may include an acrylated polyurethane resin, an acrylate-methacrylate monomer blend, a monoacrylate of mono-ethoxylated phenol, and combinations thereof.

In some embodiments, the electrode film may comprise one or more metal, metal oxide and/or carbon material additives. In some embodiments, the carbon material additives may be conductive additives (e.g., Super-P C65) and/or high-aspect ratio additives. The carbon materials may be selected from, for example, graphitic material, graphite, graphene-containing materials, hard carbon, soft carbon, carbon nanotubes, carbon nanofibers, porous carbon, conductive carbon, or a combination thereof. In some embodiments, the graphitic material can be a surface treated material. In some embodiments, the porous carbon can comprise activated carbon. In some embodiments, the porous carbon can comprise hierarchically structured carbon. In some embodiments, the porous carbon can include structured carbon nanotubes, structured carbon nanowires and/or structured carbon nanosheets. In some embodiments, the porous carbon can include graphene sheets. In some embodiments, the porous carbon can be a surface treated carbon. In some embodiments, the metal or metal oxide additives include an element selected from tin, titanium, iron, zirconium or combinations thereof. In some embodiments, metal oxide additives include an acidified metal oxide (e.g., TENIX™). In some embodiments the electrode film comprises the additive in, in about, in at most, in at most about, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 2 wt. %, 3 wt. %, 4 wt. %, 5 wt. %, 6 wt. %, 7 wt. %, 8 wt. %, 9 wt. % or 10 wt. %, or any range of values therebetween.

In some embodiments, the electrode film may comprise a surfactant. In some embodiments, the surfactant is selected from a hydrocarbon surfactant, a fluoro surfactant, a silicon surfactant, a polyoxypropylene surfactant, and combinations thereof. In some embodiments, the surfactant is selected from an amphiphilic surfactant, a cationic surfactant, an anionic surfactant, a non-ionic surfactant, a polymeric surfactant, a biosurfactant, and combinations thereof. In some embodiments, surfactants include polyethylene glycol derivatives (e.g., Triton X-100

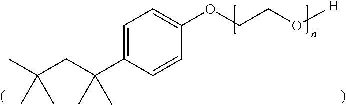

(Sigma, molecular weight 695 g/mol)), polyvinylpyrrolidone (PVP), cationic poly(ethyleneimine) (PEI, Sigma Aldrich, molecular weight 10,000 g/mol), and anionic poly(acrylic acid) (PAA, Sigma Aldrich, molecular weight 15,000 g/mol). In some embodiments, surfactant provides properties such as reduced surface tension and energy, emulsification, dispersion and solubilization for casting and/or drying of the electrode film. In some embodiments, surfactants include structure-directing agents, carbon sources, porogen agents and stabilizer agents. In some embodiments, the surfactant includes a molecular weight of, of about, of at most, or of at most about, 300 g/mol, 500 g/mol, 600 g/mol, 700 g/mol, 800 g/mol, 1,000 g/mol, 2,000 g/mol, 5,000 g/mol, 10,000 g/mol, 15,000 g/mol, 20,000 g/mol, 30,000 g/mol, 40,000 g/mol, 50,000 g/mol, 60,000 g/mol or 80,000 g/mol, or any range of values therebetween. In some embodiments the electrode film comprises the surfactant in, in about, in at most, in at most about, 0.001 wt. %, 0.005 wt. %, 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 2 wt. %, 3 wt. %, 4 wt. %, 5 wt. %, 6 wt. %, 7 wt. %, 8 wt. %, 9 wt. % or 10 wt. %, or any range of values therebetween.

The energy storage device can include any number of different types of electrolyte. For example, in some embodiments the device can include a lithium ion battery electrolyte, which can include a lithium source, such as a lithium salt, and a solvent, such as an organic solvent. In some embodiments, the device can further include an additive, such as solid electrolyte interphase (SEI)-forming additive, an electrode wetting additive, or a separator wetting additive. In some embodiments, a lithium salt can include lithium hexafluorophosphate (LiPF₆), lithium tetrafluoroborate (LiBF₄), lithium perchlorate (LiClO₄), lithium bis(trifluoromethansulfonyl)imide (LiN(SO₂CF₃)₂), lithium trifluoromethansulfonate (LiSO₃CF₃), lithium bis(pentafluoroethanesulfonyl)imide (C₄FioLiNO₄S₂), lithium bis(fluorosulfonyl)imide (F₂LiNO₄S₂), lithium bis(oxalato)borate (LiB(C₂O₄)₂), lithium difluoro(oxalato) borate (LiBF₂(C₂O₄), lithium difluorophosphate (F₂LiO₂P), lithium oxalyldifluoroborate, lithium trifluorochloroborate (LiBF₃C₁), lithium hexafluoroarsenate (LiAsF₆), combinations thereof, and/or the like. In some embodiments, a lithium ion electrolyte solvent can include one or more ethers and/or esters. For example, a lithium ion electrolyte solvent may comprise ethylene carbonate (EC), dimethyl carbonate (DMC), diethyl carbonate (DEC), ethyl methyl carbonate (EMC), vinyl carbonate (VC), propylene carbonate (PC), combinations thereof, and/or the like. For example, the electrolyte may comprise LiPF₆, ethylene carbonate, propylene carbonate and diethyl carbonate. In some embodiments, the device can include a solid state electrolyte. In some embodiments, the solid state electrolyte also functions as a separator.

Electrodes described herein may be prepared by various processes. As one example, in some embodiments an electrode film mixture (e.g. comprising the active material, binder, and optionally additives) are combined with a solvent to form an electrode film slurry. In some embodiments, the solvent is an aqueous solvent, an organic solvent, or a combination thereof. As another example, in some embodiments an electrode film mixture (e.g. comprising the active material, binder, and optionally additives) are combined and an electrode film is formed in a solvent-free dry electrode manufacturing process. In some embodiments, the electrode film mixture further comprises a surfactant and/or an additive (e.g. a conductive additive). In some embodiments, the solvent includes water, N-methylpyrrolidone (NMP), other organic solvents, or combinations thereof. The electrode film slurry may then be cast upon a substrate to form an as-cast electrode film. In some embodiments, casting of the electrode film slurry may be performed using a doctor blade, spray coating, comma bar, slot die, aerosol, gravure, screen printing, imprinting, spin-coating, electrospinning, and combinations thereof. The as-cast electrode film may then be dried and/or cured to form an electrode film. In some embodiments, the as-cast electrode film or electrode film is calendered (e.g. a roll-to-roll process). In solvent-free dry electrode manufacturing processes the electrode film may be formed using dry materials, such as a calendering process. In some embodiments, the substrate which the dry electrode film or electrode film slurry is cast upon is a current collector, and as such an electrode is formed once the electrode film is deposited, dried and/or cured.

Drying may be performed by heating the as-cast electrode film to evaporate the solvent. Curing may be performed to polymerize the binder to form a binder matrix within the electrode film. In some embodiments, curing is performed by an energy source, such as for example photons and/or electrons. In some embodiments, curing is performed by an electron beam (“e-beam” or “EB”). In some embodiments, the curing is performed with an EB with, with about, with at least, or with at least about, 50 kV, 100 kV, 150 kV, 200 kV, 250 kV 300 kV, or any range of values therebetween. In some embodiments, the curing is performed with an EB with, with about, with at least, or with at least about, 15 kGy, 20 kGy, 25 kGy, 30 kGy, 40 kGy, 50 kGy, 60 kGy, 70 kGy, 80 kGy or 100 kGy, or any range of values therebetween.

### EXAMPLES

Example embodiments of the present disclosure, including processes, materials and/or resultant products, are described in the following examples.

### Example 1—EB Formulation

Battery electrodes slurries were created using an active material (e.g., carbon monofluoride (CFx) or MnO₂), a conductive additive (e.g., Super-P C65), a radiation curable binder (e.g., Ucecoat 7690 (“UC7690” or “UC90”)) as the primary polymer binder, a cellulose based polymer (e.g., a cellulose-based polymer such as aqueous carboxymethyl cellulose (CMC) and Na-CMC, or methylcellulose) as a secondary binder, and in some examples a surfactant was used for wetting. The different surfactants used included nonionic Triton X-100 with a molecular weight of 695 g/mol, cationic poly(ethyleneimine) (PEI) with a molecular weight of 10,000 g/mol, and anionic poly(acrylic acid) (PAA) with a molecular weight of 15,000 g/mol. The slurries were created by sequentially adding each of the components to water and dispersing them using a variety of dispersion techniques including a Flacktek SpeedMixer, a Thinky Mixer, and/or a planetary mixer. Table 1 summarizes the solid wt % for each of the formulations.

TABLE 1
CFx E-beam Curable Slurry Formulation Summary

| Formulation | Solid wt % |
|---|---|
| F1 | 85-90% CFx |
| | 3-6% C65 |
| | 5-10% UC7690 |
| | 0.1-2% CMC |
| | 0.1-2% Triton X-100 |
| F2 | 85-90% CFx |
| | 3-6% C65 |
| | 5-10% UC7690 |
| | 0.1-2% CMC |
| | 0.01-0.2% PEI |
| F3 | 85-90% CFx |
| | 3-6% C65 |
| | 5-10% UC7690 |
| | 0.1-2% CMC |
| | 0.1-2% PAA |
| F4 | 90-95% CFx |
| | 2-5% C65 |
| | 1-3% Radiation Curable Binder |
| | 1-3% Cellulose Based Polymer |
| | 1-3% Triton X-100 |
| F5 | 90-95% CFx |
| | 2-5% C65 |
| | 1-3% Radiation Curable Binder |
| | 1-3% Cellulose Based Polymer |
| | 0.01-0.3% PEI |
| F6 | 93% MnO₂ |
| | 3% C65 |
| | 2% UC7690 |
| | 2% Na-CMC |

Once well dispersed, the slurries were then used to create battery electrodes by casting them onto an aluminum substrate using a doctor blade. After deposition the water was removed from the resulting electrode films by allowing them to air dry for 15-20 minutes and subsequently placed under a forced air drier, held at 120° C., for 10-15 minutes. The electrodes were then calendered at 80° C. until a porosity of 40% was achieved for each. Once the electrodes were dry, a selection were cured using an electron beam (EB) at various high voltages (140 kV-200 kV) and doses (20 kGy-100 kGy) while under an inert nitrogen atmosphere, while the remaining were left uncured. Each cured electrode was cured such that a dosage of 20 kGy was achieved throughout the depth of the film. Table 2A shows examples of the typical electrode loadings of the EB formulations for formulations F1, F2 and F3.

TABLE 2A
Summary of Cathode Electrode Types

| | | Loadings |
|---|---|---|
| Formulations | Substrates | (mg/cm²) |
| F1 | Aluminum Foil | 12.5 |
| F2 | Aluminum Foil | 26.0 |
| F3 | Aluminum Foil | 53.0 |

The use of UC7690 as the radiation polymer binder within the slurry mixture produced favorable rheological qualities. In addition, the surfactants added to each formulation improved the dispersal of the hydrophobic CFx, with no successful dispersion occurring without their inclusion.

### Example 2—PVDF Formulation

Battery electrodes slurries were created using carbon monofluoride (CFx) as the active material, Super-P C65 (conductive carbon black powder) as a conductive additive, and polyvinylidene fluoride (PVDF) in N-methylpyrrolidone (NMP) as the polymer binder. The slurries did not include a surfactant. The slurries were created by sequentially adding each of the components to NMP solvent and dispersing them using a variety of dispersion techniques including a Flacktek SpeedMixer, a Thinky Mixer, and/or a planetary mixer. Once well dispersed, the slurries were then used to create battery electrodes through techniques including a doctor blade, spray coating, a comma bar, and/or a slot die, to deposit the slurry material onto a substrate through a roll-to-roll process. The substrates employed during deposition included aluminum foil and carbon-coated aluminum foil and various solid weight loadings between 20 and 30 mg/cm² were achieved. After deposition the volatile NMP solvent was removed from the resulting electrode films by drying them using a convective drying process. Following the removal of the solvent from the electrodes it was recollected through a solvent recovery process. The electrodes were initially dried in a convection oven at 80° C. for 10 minutes, calendered to a porosity of 40% at 80° C., and subsequently vacuum dried for 12 hours at 100° C. Table 2B shows examples of the typical electrode loadings of the EB formulations for formulations F7 and F8.

TABLE 2B
Summary of Cathode Electrode Types

| | | Loadings |
|---|---|---|
| Formulations | Substrates | (mg/cm²) |
| F7 | Aluminum Foil | 26 |
| F8 | Carbon-Coated | 26 |
| | Aluminum Foil | |

### Example 3—EB Curing

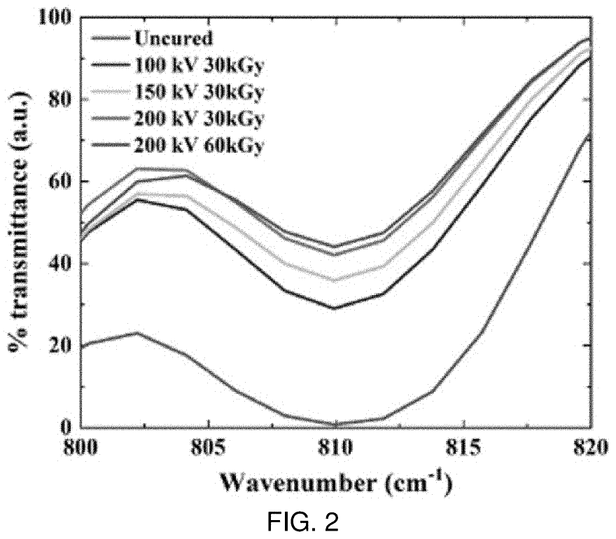

Upon acrylate-based polyurethane resin exposure to an electron beam, these resins undergo a free radical induced polymerization reaction, which yields crosslinking of neighboring acrylate groups. The relative degree of crosslinking in an exposed sample of acrylate polyurethane resin can be discerned through Fourier transform infrared (FTIR) spectroscopy. The intensity of the characteristic absorption peak of the C═C bond in each of the acrylate groups near 810 cm⁻¹ corresponds to the concentration of unreacted arylate groups after exposure. FTIR spectra of cured and uncured samples of Ucecoat 7689 were collected using a VERTEX 70v spectrometer at the Nanoscale Characterization Facility at Indiana University. Each sample was prepared by depositing pure Ucecoat 7689 resin onto a glass substrate and casting it across the surface with a doctor blade. The resin was then allowed to dry and was subsequently placed within the e-beam emitter chamber for exposure. In order to diminish the presence of oxygen, which can inhibit crosslinking, the chamber was purged with 99.99% pure nitrogen gas prior to turning the emitter on and the gas flow was maintained throughout the exposure for each sample. The samples were exposed at a range of high voltages and dosages from 100 to 200 kV and 30 to 60 kGy respectively. An uncured sample was also prepared as a reference for the FTIR measurements. The resulting FTIR spectra for each of the different samples is shown in FIG. 2. Each measurement on the Vertex 70v spectrometer was collected in transmission mode at a resolution of 4 cm⁻¹ and the final curves were determined by averaging over 32 separate scans. A clear trend of decreasing peak intensity is clearly observed with increasing EB high voltage and dosage as compared to the uncured sample, indicating the crosslinking of more acrylate groups.

### Example 4—Linear Sweep Voltammetry

To investigate any differences that exist within the electrochemistry that occurs between the cells containing PVDF binder and EB curable polymer, linear sweep voltammetry (LSV) measurements were performed on coin cells of each type. During cell discharge within the Li-CFx system, lithium ions flow from the anode to the CFx cathode through the electrolyte and the separator while electrons simultaneously travel through the outside circuit and reduce the cathode. The overall cell discharge reaction can be summarized by:

CFₓ+xLi→C+xLiF

with the half reactions at the anode and cathode being:

Anode: xLi+xS→xLi⁺S+xe⁻

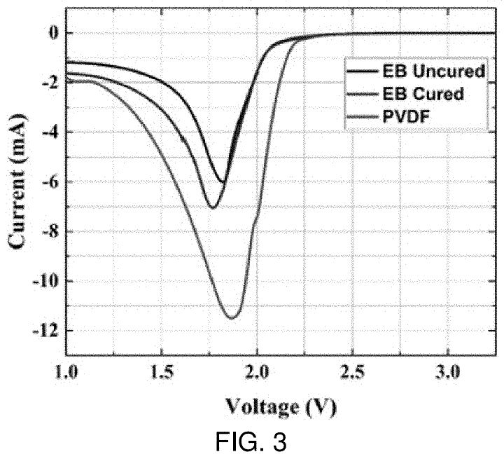

Cathode: CFₓ+xLi⁺S+xe⁻→C+xLiF+xS

where S denotes the electrolyte solvent molecules coordinated with each Li⁺ during ion flow. LSV allows one to sweep over the voltage window of interest at a fixed scan rate (potential change per unit time) and observe oxidation and reduction reactions as current changes within the scan range. The linear sweep voltammetry (LSV) profiles were collected in the voltage window from the open circuit potential (˜3.25V for each cell) to 1V at a scan rate of 0.1 mV/s. FIG. 3 shows the results of the LSV measurements for PVDF cells as compared to those that contain a polymer electrode that was created using the F2 formulation in EB cured and uncured forms. Multiple cells of each type were tested, and a representative curve was extracted for each. A clear reduction peak near 1.85V is observed for the PVDF system. The cells containing cured and uncured EB polymer electrodes show a reduction peak occurring at a slightly lower reduction potential, with the uncured sample being shifted to about 1.8V and the cured being at about 1.75V. The area of the reduction peak of the PVDF samples was larger than that of the EB samples, indicating that an increased amount of active material was involved within the redox reaction. This was a result of a slightly higher weight loading for the PVDF electrodes as compared to the EB electrodes. FIG. 3 shows no clear spurious peaks that would indicate unwanted side reactions are visible during measurement. As such, these measurements indicate that the EB polymers, whether cured or uncured are electrochemically inert over the potential window of interest for discharging our Li-CFx cells.

### Example 6—Discharge Performances

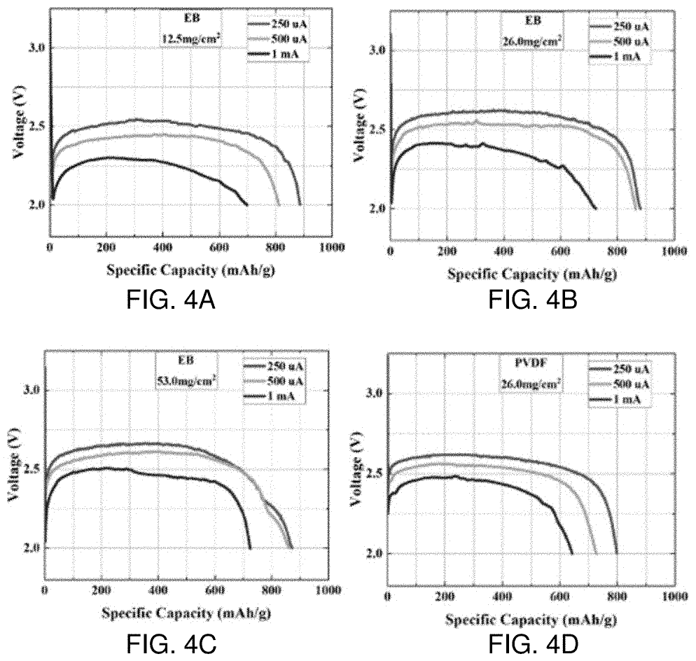

To evaluate the discharge performance of EB Li-CFx cells, galvanostatic discharge data was collected on a Neware CT-4008T battery analyzer for cells at various weight loadings and currents. Cells made using formulation F1, which include surfactant Triton X-100, with weight loadings of 12.5 mg/cm², 26.0 mg/cm² and 53.0 mg/cm² were each discharged at the constant currents of 250 μA, 500 μA and 1 mA. The cells were discharged from their open circuit potential (˜3.25 V) down to a cut-off voltage of 2.0V. Prior to cell assembly all the EB CFx electrodes used to make the cells were cured such that a dosage of 20 kGy was achieved throughout the depth of the film. PVDF cells, which do not include a surfactant, were also assembled with a PVDF CFx electrode at a weight loading of 26.0 mg/cm² and discharged at the same constant current values as the EB cells. FIGS. 4A-4D show the galvanostatic discharge data of the EB and PVDF cells as plots of voltage as a function of specific capacity, where FIG. 4A shows the discharge data for a 12.5 mg/cm² loading EB electrode, FIG. 4B shows the discharge data for a 26.0 mg/cm² loading EB electrode, FIG. 4C shows the discharge data for a 53.0 mg/cm² loading EB electrode, and FIG. 4D shows the discharge data for a 26.0 mg/cm² loading PVDF electrode. Each curve is an average discharge curve over multiple tested cells of the same weight loading and discharged at the same current value. The cells all show a voltage delay at the start of their discharge.

The EB cells with surfactant show a voltage drop in their initial delay of about ˜0.5V as compared to the ˜0.25V drop of the PVDF cells without surfactant, implying that during the initial discharge phase the electronic conductivity of the EB cathodes are lower than that of the PVDF counterpart. All cell types show a voltage plateau ≥2.5V when discharged at 250 uA, with a monotonic decrease of the observed plateau for the larger discharge currents. This monotonic decrease in voltage with increasing discharge currents indicates a difference in the potential of the solvated Li⁺ ion. With larger discharge rates increased bonding strength is induced between the Li⁺ and electrolyte solvent and as a result it becomes more difficult to form a lithium-fluorine (Li—F) pair within the cathode. Small differences in the shape of the voltage plateau are observed when comparing the higher weight loading samples (i.e. 53.0 mg/cm²) to the lower weight loading samples, but the curves of the 12.5 and 26.0 mg/cm² display a similar shape regardless of the binder system used. Although the PVDF cells without surfactant achieve a specific capacity of at 800 mAh/g at 250 μA, the EB cells with surfactant achieved a greater value of 880 mAh/g when discharged at the same current value. Furthermore, the EB cells with surfactant demonstrated an about 15% increase in energy density and improved currents relative to the PVDF cells without surfactant at the same weight loading.

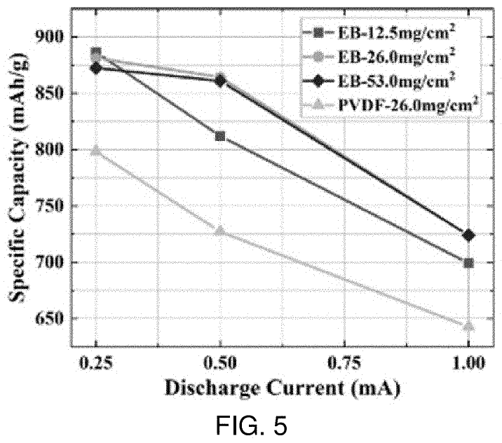

FIG. 5 shows the specific capacities of these cells as a function of discharge current, where each point is determined by extracting the specific capacity at the voltage cut off for the galvanostatic discharge curves. Here it is clear that all EB cells tested, regardless of weight loading, show a higher relative specific capacity value as compared to the PVDF counterpart at 26.0 mg/cm².

The theoretical specific discharge capacity (Qₜₕ) of CFx can be written as a function of x (the ratio of F to C) as:

$${Q}_{th} ( x ) = \frac{x F}{3.6 ( 12 + 19 x )}$$

where F is the Faraday constant and 3.6 is a unit conversion factor. Utilizing this expression and taking x=1.12 for the CFx 1000, one obtains an expected value of 902 mAh/g. EB cells achieve ˜95% of this value at the lowest current rate, and the PVDF cells only achieve 89%. This demonstrates that performance of EB binder systems in Li-CFx cells may be a viable replacement for PVDF in primary battery cells.

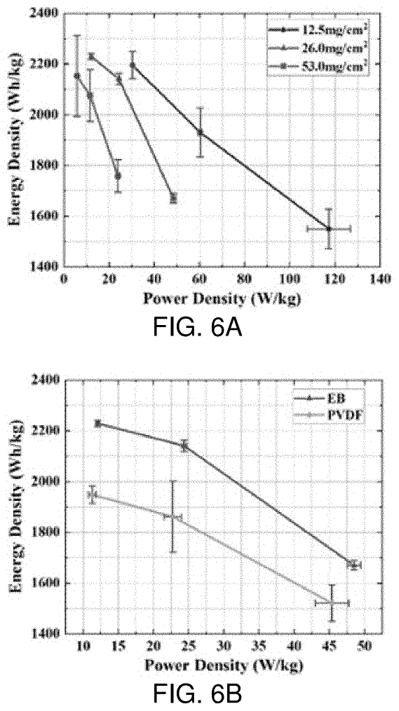

FIGS. 6A and 6B are Ragone plots that provide an overview of the performance metrics of the EB and PVDF cells as a function of their specific capacity at different discharge currents. FIGS. 6A and 6B display the relationship between energy density (Wh/kg) and power density (W/kg) for the different cell types. The energy density (E) and power density (P) are determined from the discharge curves using the following two expressions:

$$E = \frac{Q ( I ) \times < V ( I ) >}{m} P = \frac{I \times < V ( I ) >}{m}$$

where Q(I) and <V(I)> are the discharge capacity in Ah and the average voltage respectively obtained when discharging at a current I, with a mass m of active material within the CFx electrode. A Ragone plot conveys the relationship between the capacity obtained under a certain discharge current to the average working cell potential throughout discharge, for a given amount of active material within the electrode.

FIG. 6A shows the performance metrics of the EB cells at the different weight loadings. The points shown represent averages over multiple discharge curves, with values extracted at the voltage cut-off for each different cell. The error bars on each point show the standard deviation away from the mean of all the cells considered in both the horizontal and vertical directions. A trend of diminished power density is observed for cells of increasing weight loading, as expected for cells that contain electrodes of higher thickness. FIG. 6B shows the comparison of EB and PVDF cells at the same weight loading of 26.0 mg/cm². The EB cells show a higher energy density and power density for all tests as compared to the PVDF cells, reflective of the higher specific capacities and marginally higher average voltages achieved in the EB case. These results may suggest that lithium-ion diffusion rates and lithium-ion cathode insertion are improved in the EB system as compared to the equivalent PVDF system.

### Example 8—Discharge Testing

In discharge testing, a cut-off voltage condition of 1.8V was set and coin cells from each type of EB formulations and PVDF cells were all tested. The cells were cycled through a sequence of a constant current ‘rest’ discharge phase at 20 uA for an interval of 5 minutes followed by a pulse ‘event’ at 7.6 mA for 6 ms. This sequence was repeated for a total time frame of 200 hours at which point each cell was then discharged at 300 uA to its final capacity.

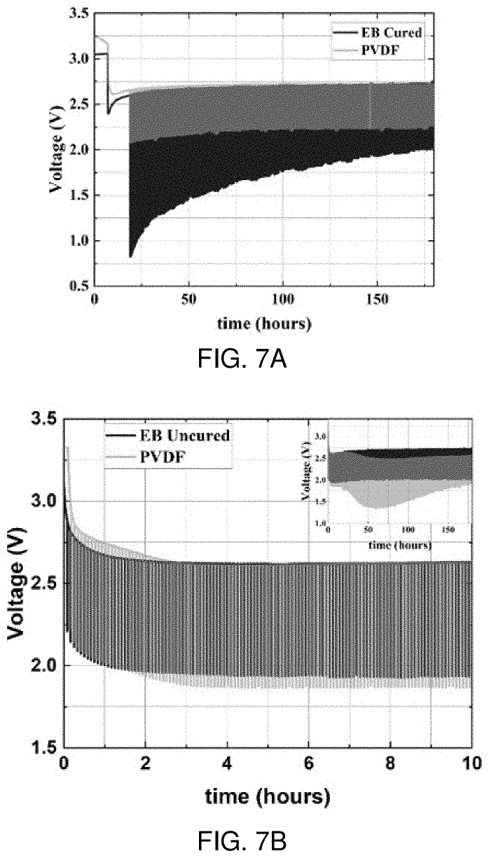

FIG. 7A shows a comparison of the pulsing performance after a 12-hour discharge at 20 uA between a cured EB cell of formulation F1 with surfactant and a PVDF cell without surfactant, each cast on an aluminum foil substrate. During testing, a voltage delay was observed in all cell types during initial cell discharge. This voltage delay was directly reflected in the pulse testing if the cells begin pulsing immediately, with some cured EB cells with surfactant showing a substantial voltage drop from OCV to less than 0V during initial discharge. The effects of this voltage delay were also reflected in the PVDF electrodes without surfactant coated on an aluminum substrate, with voltage drops from OCV to <1.0V, as seen in FIG. 7B. It was found that this voltage drop could be diminished if the cells were first discharged for 12 hours prior to their pulse testing.

After the initial discharge the PVDF without surfactant cell maintains its voltage above 2V throughout the remainder of the experiment with a relatively constant pulse voltage drop of about 0.5V. In comparison, the EB with surfactant cell shows a significant voltage delay after the 12-hour treatment period, with a monotonically decreasing pulse voltage drop that begins at a value >1.5V once pulsing began. This increased voltage delay of the EB with surfactant cell is reflective of electronic conductivity issues and rate performances of the CFx chemistry.

Through iteratively testing different curing conditions for EB with surfactant formulations voltage delay and rate performance were improved. It was found that, surprisingly, EB with surfactant cells that housed an uncured CFx cathode displayed improved pulsing performance as compared to those cells that are cured. Each EB with surfactant cell type (i.e. F1, F2, F3, F4 and F5) showed improved pulsing performance and voltage delay when the internal CFx cathodes were left uncured, with the F2 formulation showing the best performance. FIG. 7B shows the comparison between an uncured EB with surfactant cell made using F2 and a PVDF without surfactant cell, both cast on an aluminum substrate. This cell shows much improved performance over the cured F1 cell shown in FIG. 7A, with no obvious voltage delay and a voltage that is maintained above 2V throughout the whole testing period.

Furthermore, FIG. 7B shows that although it is clear that early on within the pulsing sequence (large panel) each cell type performs similarly, with a voltage drop of about 0.5 V when testing out through 10 hours, at larger time frames within the testing (figure inset) it becomes clear that while the voltage drop of the EB Uncured with surfactant cell remains relatively constant that of the PVDF without surfactant diminishes and falls below a minimum threshold of ˜1.5 V during discharge. This indicates that using the EB binder as the polymer of choice, even when that polymer has not been through an ebeam curing process, rather than PVDF can yield enhanced pulsing performance for Li-CFx batteries.

### Example 9—Carbon-Coated Al

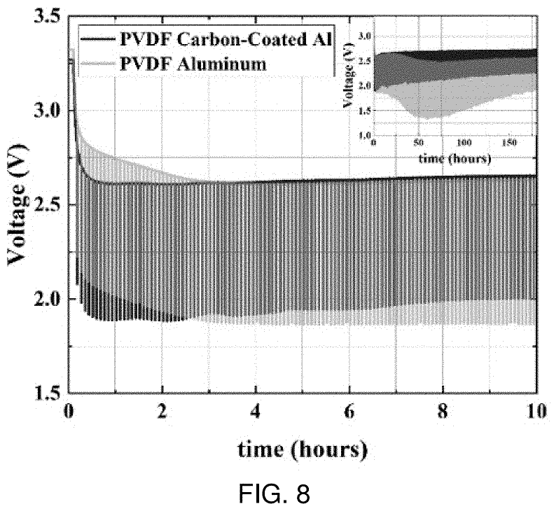

FIG. 8 shows the results of the pulsing performance of coin cells with electrodes that contain PVDF binder and are cast on either a bare aluminum or a carbon-coated aluminum substrate. In FIG. 8 (large panel) with testing within 10 hours, it can be seen that early on within the pulsing sequence each cell type performs similarly, with a voltage drop of about 0.5 V when testing out through 10 hours. However, at larger time frames (inset) within the testing over an extended period of 180 hours, it becomes clear that while the voltage drop of the cell made with carbon-coated aluminum foil improves and the voltage never dropped below 2.0V for over 150 hours of pulsing, whereas that of the aluminum foil diminishes and falls below a minimum threshold of ˜1.8 V and dropped 1.5V. This indicates that carbon-coated aluminum foil may enhance the electronic conductivity of the substrate during operation of the resulting CFx battery cells.

### Example 10—NMC Electrodes

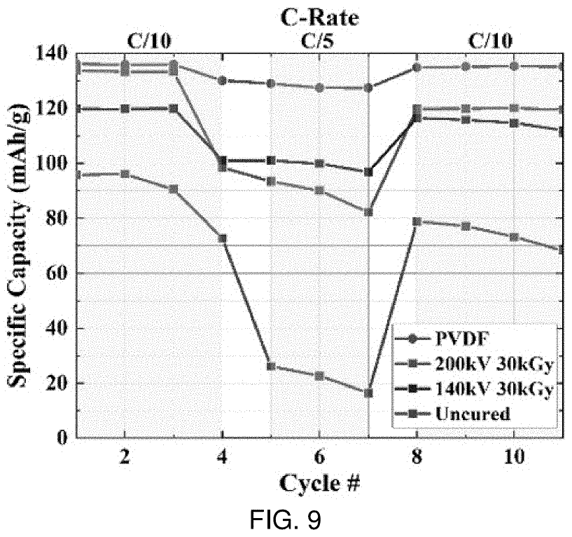

A formulation with NMC532 as an active material containing NMC/C65/UC7690/CMC/Solsperse 39000 (polymeric dispersant, Lubrizol) at a 87/5/7/0.5/0.5 by solid wt % and a ratio of solids content to water of 69:31 was prepared. The cathode slurry was coated and subsequently underwent different curing conditions, such as uncured, 140 kV, and 200 kV e-beam cure at 30 kGy. These electrodes where then assembled into rechargeable, half cells and cycled at different rates (C/10 and C/5). FIG. 9 shows the specific capacity of e-beam curable batteries and thermally curable batteries over 10 cycles. The study showed the e-beam curable batteries had a performance of only 20% less compared the thermal curable batteries, but which was widely dependent on e-beam conditions. As such, the results indicate that the e-beam manufacturing process may be adopted for rechargeable batteries.

### Example 11—MnO₂ Cell Discharge Performances

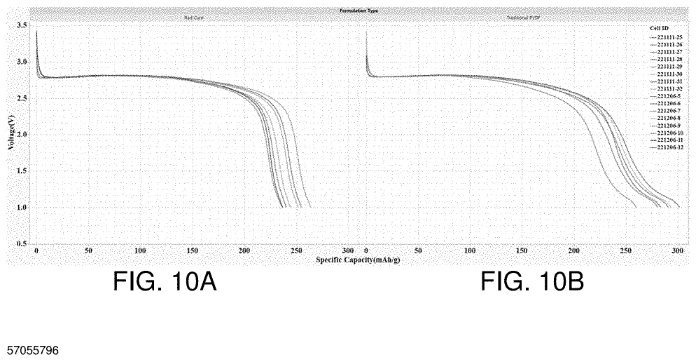

To evaluate the discharge performance of EB Li—MnO₂ cells, galvanostatic discharge data was collected for cells made using formulation F6. FIGS. 10A and 10B show the galvanostatic discharge data of the EB Li—MnO₂ cells with an EB radiation cured binder or PVDF binder, respectively, as plots of voltage as a function of specific capacity. FIGS. 10A and 10B demonstrate the radiation-curable polymers with MnO₂ as an active material can produce batteries with similar performances as PVDF-based batteries, while retaining the manufacturing benefits of a radiation curable battery.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount, depending on the desired function or desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

The headings provided herein, if any, are for convenience only and do not necessarily affect the scope or meaning of the devices and methods disclosed herein.

What is claimed is:

1. A cathode electrode film, comprising:
a cathode active material comprising a material selected from the group consisting of carbon monofluoride, manganese dioxide and combinations thereof; and
a binder selected from the group consisting of an acrylated polyurethane resin, a hydroxy modified acrylated polyurethane resin, an acrylate-methacrylate monomer blend, a monoacrylate of mono-ethoxylated phenol, a cellulose, trimethylolpropane ethoxy triacrylate (TMPEOTA), polytetrafluoroethylene (PTFE), a polyolefin, polyalkylenes, polyethers, styrene-butadiene, co-polymers of polysiloxanes, a polysiloxane, branched polyethers, polyvinylethers, co-polymers thereof, and combinations thereof.

2. The cathode electrode film of claim 1, wherein the polyolefin is selected from the group consisting of polyethylene (PE), polypropylene (PP), polyvinylidene fluoride (PVDF), co-polymers thereof, and combinations thereof.

3. A cathode electrode, comprising:
a current collector; and
the cathode electrode film of claim 1 disposed over the current collector.

4. The cathode electrode of claim 3, further comprising a carbon coating disposed between the current collector and the cathode electrode film.

5. An energy storage device, comprising:
the cathode electrode of claim 3;
an anode electrode; and
a housing, wherein the cathode and anode electrodes are disposed within the housing.

6. A method of fabricating the cathode electrode of claim 3, comprising:
combining the cathode active material, binder and a solvent to form a slurry; and
casting the slurry over the current collector to form the cathode electrode.

7. The method of claim 6, further comprising exposing the cathode electrode to an electron beam.

8. An electrode film, comprising:
an active material; and
a binder selected from the group consisting of an acrylated polyurethane resin, a hydroxy modified acrylated polyurethane resin, an acrylate-methacrylate monomer blend, a monoacrylate of mono-ethoxylated phenol, a cellulose, trimethylolpropane ethoxy triacrylate (TMPEOTA), polytetrafluoroethylene (PTFE), a polyolefin, polyalkylenes, polyethers, styrene-butadiene, co-polymers of polysiloxanes, a polysiloxane, branched polyethers, polyvinylethers, co-polymers thereof, and combinations thereof.

9. The electrode of claim 8, wherein the active material is an anode active material.

10. An electrode film, comprising:
an active material;
a binder selected from the group consisting of an acrylated polyurethane resin, a hydroxy modified acrylated polyurethane resin, an acrylate-methacrylate monomer blend, a monoacrylate of mono-ethoxylated phenol, a cellulose, trimethylolpropane ethoxy triacrylate (TMPEOTA), polytetrafluoroethylene (PTFE), a polyolefin, polyalkylenes, polyethers, styrene-butadiene, co-polymers of polysiloxanes, a polysiloxane, branched polyethers, polyvinylethers, co-polymers thereof, and combinations thereof, and
a surfactant.

11. The electrode film of claim 10, wherein the active material is a cathode active material.

12. The electrode film of claim 11, wherein the cathode active material is selected from the group consisting of carbon monofluoride, manganese dioxide, lithium iron phosphate (LFP), lithium cobalt oxide (LCO), nickel manganese cobalt oxide (NMC), nickel cobalt aluminum oxide (NCA), lithium titanate (LTO), lithium manganese iron phosphate (LMFP), and combinations thereof.

13. The electrode film of claim 10, wherein the electrode film comprises about 85-95 wt. % of the active material.

14. The electrode film of claim 10, wherein the surfactant is selected from the group of consisting of a non-ionic surfactant, a polymeric surfactant, and combinations thereof.

15. The electrode film of claim 10, wherein the surfactant comprises a molecular weight of at most about 50,000 g/mol.

16. The electrode film of claim 10, wherein the surfactant is selected from the group consisting of a polyethylene glycol derivative, polyvinylpyrrolidone, poly(ethyleneimine), poly(acrylic acid), and combinations thereof.

17. The electrode film of claim 10, wherein the electrode film comprises about 0.01-0.5 wt. % of surfactant.

18. The electrode film of claim 10, further comprising a conductive additive.

19. The electrode film of claim 18, wherein the electrode film comprises about 1-10 wt. % of the conductive additive.

20. The electrode film of claim 10, wherein the electrode film comprises about 3-15 wt. % of the binder.
